(19) United States
(12) Patent Application Publication
(10) Pub. No.: US 2026/0350327 A1
(43) Pub. Date: Nov. 5, 2026

(54) RFID READER SYSTEM AND METHOD

(71) Applicant: Avery Dennison Retail Information Services LLC, Mentor, OH (US)

(72) Inventor: Mark W. ROTH, North Miami, FL (US)

(21) Appl. No.: 19/119,437

(22) PCT Filed: Nov. 21, 2023
(86) PCT No.: PCT/IB2023/061746

§ 371 Date: Apr. 9, 2025

Related U.S. Application Data
(60) Provisional application No. 63/385,334, filed on Nov. 29, 2022.

(51) Int. Cl. G06K 7/10

(52) U.S. Cl. CPC G06K 7/10009

(57) ABSTRACT

In some embodiments, an RFID reader system is disclosed that includes a first region configured to allow movement of one or more RFID devices into the first region, and a second region configured to allow movement of the one or more RFID devices into the second region after traveling through the first region. The RFID reader system also includes a first transceiver configured to provide the one or more RFID devices traveling through the first region with a precharge using a first command. The RFID reader system also includes a second transceiver configured to use the precharge from the first transceiver to accelerate and complete communication with the one or more precharged RFID devices while the one or more precharged RFID devices are traversing the second region.

### TECHNICAL FIELD

The present subject matter, in general, relates to the field of RFID reader systems and methods. In some embodiments, the present subject matter relates to an RFID reader system including a first region and a second region, a first transceiver configured to provide the RFID device with a precharge to one or more RFID devices and a second transceiver configured to use the precharge to enable communication with the precharged one or more RFID devices.

### BACKGROUND

Globally, use of radio frequency identification continues to be adopted for use in tracking goods or items. Radio-frequency identification (“RFID”) is the use of electromagnetic energy (“EM energy”) to stimulate or interrogate a responsive device (known as an RFID “tag”, inlay, or transponder) to identify itself and, in some cases, provide additional stored data. RFID tags typically include a semiconductor device, i.e., an integrated circuit (IC), which is commonly referred to as the IC or “chip.” The chip contains the memory and operating circuitry for the tag and is connected or otherwise coupled to an antenna.

A variety of solutions have been implemented to capture read events of RFID tagged items or to track movement of RFID tagged items. Such tracking may include mobile devices such as hand-held RFID scanners or fixed RFID reading infrastructure. Facilities that utilize conveyor systems as port of a material handling strategy may implement RFID tunnels. Such RFID tunnels may be an integral part of logistics and supply chain implemented with the fixed infrastructure at key points such as receiving and shipping areas. Receiving areas may use RFID tunnels mounted over the conveyor belts that extend into a cargo transport (i.e. trailers or sea containers). Notably, tracking within the shipping area for inbound or outbound items is important to prevent waste or loss, and an RFID reader system such as a tunnel may allow visibility of the RFID tagged items.

In some systems, packaged items being read-by the RFID reader system may include an RFID tagged item that is made more difficult to detect because of the number of items in the package, the distance between packages, the presence of blocking materials inside or outside the package, and/or the speed at which the package is traveling past the RFID reader system.

If one or more of these effects are sufficient to prevent accurate reads of one or more of the RFID tags within the package, the utility of the RFID reader system and the RFID tags within the package may be substantially reduced. For example, the failure to accurately read the tags may result in lost items, requests for replacements, underpayment or overpayment, lost time due to manual rechecking, or other issues that may cause increased costs and/or wasted time.

For example, for some systems, a larger RF field may be used to attempt to improve accuracy of reads at higher speeds. However, for some of these systems, more than one package may accidentally be read and attributed to a single package, thus decreasing accuracy. Furthermore, trying to use a very narrow beam pattern to mitigate over-reads might result instead in an increased failure to read some tags, which would be counterproductive.

Therefore, in light of foregoing discussions, there is a need to overcome the limitations and disadvantages related to conventional conveyor reader systems and methods to improve and enhance the ongoing demand and supply in the global market.

### SUMMARY

Some embodiments of the present disclosure include an RFID reader system that precharges one or more RFID devices in a first region and reads the precharged one or more RFID devices in a second region. Some embodiments include a conveyor including a first region and a second region, the conveyor is configured to move one or more RFID devices from the first region to the second region.

Some embodiments of the present disclosure include an RFID reader system that includes a first region configured to allow movement of one or more RFID devices into the first region, through the first region, and out of the first region. The RFID reader system may further include a second region configured to allow movement of the one or more RFID devices into the second region after traveling through the first region, through the second region, and out of the second region. The RFID reader system may also include a first transceiver configured to provide the one or more RFID devices traveling through the first region with a precharge using a first command. The RFID reader system may also include a second transceiver configured to use the precharge from the first transceiver to accelerate and complete communication with the one or more precharged RFID devices while the one or more precharged RFID devices are traversing the second region.

In some embodiments, the precharge may enable the second transceiver to initiate and perform communication with the precharged one or more RFID devices moving through the second region at an average rate that is above a threshold. In some embodiments, the threshold rate is at least 3 feet per second. In some embodiments, the system includes a conveyor for transporting the one or more RFID devices through the first region and the second region. In some embodiments, the one or more RFID devices are configured to switch between a first state and a second state. In some embodiments, the first state of the one or more RFID devices includes a secured state that blocks access to the one or more RFID devices in the secured state. In some embodiments, the second state of the one or more RFID devices includes an accessible state that allows the one or more RFID devices in the second state to communicate with one or more authorized readers. In some embodiments, the system further includes a tunnel enclosing the first region and the second region. In some embodiments, the system further includes one or more Radio Frequency (RF) light curtains disposed between the first region and the second region to avoid leakage of RF signals and to enable efficient communication between the one or more RFID devices and only one of the first transceiver and the second transceiver at a time. In some embodiments, the system further includes one or more sensors to detect a position of the one or more RFID devices.

In some embodiments, a method for reading RFID devices in an RFID reader system that includes a first region and a second region, the first region being configured to allow movement of one or more RFID devices into the first region, through the first region, and out of the first region, and the second region being configured to allow movement of the one or more RFID devices into the second region after traveling through the first region, through the second region, and out of the second region, the reading system further including a first transceiver, and a second transceiver. The method may include using the first transceiver, providing the one or more RFID devices traveling through the first region with a precharge using a first command. In some embodiments, the method further includes using the second transceiver, using the precharge from the first transceiver to accelerate and complete communication with the one or more precharged RFID devices while the one or more RFID devices are traversing the second region.

The RFID reading method of claim 11, wherein the precharge enables the second transceiver to initiate and perform communication with the precharged one or more RFID devices moving through the second region at an average rate that is above a threshold. In some embodiments, the threshold rate is at least 3 feet per second. In some embodiments, the RFID reader system includes a conveyor for transporting the one or more RFID devices through the first region and the second region. In some embodiments, the one or more RFID devices are configured to switch from a first state to a second state. In some embodiments, the first state of the one or more RFID devices includes a secured state, wherein the secured state blocks access to the one or more RFID devices. In some embodiments, the second state of the one or more RFID devices includes an accessible state, wherein the accessible state allows communication of the one or more RFID devices with one or more authorized readers. In some embodiments, the RFID reader system further includes a tunnel enclosing the first region and the second region. In some embodiments, the RFID reader system further includes one or more Radio Frequency (RF) light curtains disposed between the first region and the second region to avoid leakage of RF signals and to enable efficient communication between the one or more RFID devices and only one of the first transceiver and the second transceiver at a time. In some embodiments, the RFID reader system further includes one or more sensors to detect a position of the one or more RFID devices.

These and other features, aspects, embodiments, and advantages of the present subject matter will be better understood with reference to the following description and appended claims. This summary is provided to introduce a selection of concepts in a simplified form. This summary is not intended to identify key features or essential features of the claimed or disclosed subject matter, nor is it intended to be used to limit the scope of the claimed subject matter.

### BRIEF DESCRIPTION OF DRAWINGS

The summary above, as well as the following detailed description of illustrative embodiments, is better understood when read in conjunction with the appended drawings. For the purpose of illustrating the present subject matter, exemplary constructions of the subject matter are shown in the drawings. However, the present subject matter is not limited to specific methods and instrumentalities disclosed herein. Moreover, those in the art will understand that the drawings are not to scale. Wherever possible, like elements have been indicated by identical numbers.

Embodiments of the present subject matter will now be described, by way of example only, with reference to the following diagrams wherein:

FIGS. 1A, 1B and 1C are illustrations of schematic diagrams of an RFID reader system, in accordance with various exemplary embodiments of the present subject matter;

FIG. 1A is a cross sectional view of the RFID reader system, in accordance with an embodiment;

FIG. 1B is a perspective view of the RFID reader system, in accordance with an embodiment;

FIG. 1C is a side view of the RFID reader system, in accordance with an embodiment; and

FIG. 2 is a flow chart of a method for reading RFID devices in an RFID reader system, in accordance with various exemplary embodiments of the present subject matter.

In the accompanying drawings, an underlined number is employed to represent an item over which the under lined number is positioned or an item to which the under lined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

In overview, some embodiments of the present subject matter relate to identifying association of an entity. Some embodiments include providing validated associations of the entity, and the associations may be determined based on at least one of: recency, frequency, proximity, and semantics thereof.

The following detailed description illustrates various embodiments of the present subject matter and ways in which they can be implemented. Although some modes of carrying out the present subject matter have been disclosed, those skilled in the art would recognize that other embodiments for carrying out or practicing the present subject matter are also possible. Some disclosed embodiments include one or more of methods, devices, and/or systems for locating, identifying, and/or communicating about or RFID tags or RFID tagged items, goods, articles, inventory items, and packages have been disclosed herein.

In some embodiments, an RFID reader system includes:
a first region configured to allow movement of one or more RFID devices into the first region, through the first region, and out of the first region
a second region configured to allow movement of the one or more RFID devices into the second region after traveling through the first region, through the second region, and out of the second region;
a first transceiver configured to provide the one or more RFID devices traveling through the first region with a precharge using a first command; and
a second transceiver configured to use the precharge from the first transceiver to accelerate and complete communication with the one or more precharged RFID devices while the one or more precharged RFID devices are traversing the second region.

In some embodiments, an RFID reader system includes:
a conveyor including a first region and a second region, the conveyor is configured to move one or more RFID devices from the first region to the second region;
a first transceiver configured to provide the RFID device with a precharge using a first command to the one or more RFID devices in the first region; and
a second transceiver configured to use the precharge to enable communication with the precharged one or more RFID devices when the one or more RFID devices traverses the second region.

In some embodiments, a method for reading RFID devices in an RFID reader system comprises a first region configured to allow movement of one or more RFID devices into the first region, through the first region, and out of the first region, a second region configured to allow movement of the one or more RFID devices into the second region after traveling through the first region, through the second region, and out of the second region, a first transceiver, and a second transceiver. The method may include, using the first transceiver, providing the one or more RFID devices traveling through the first region with a precharge using a first command, and using the second transceiver, using the precharge from the first transceiver to accelerate and complete communication with the one or more precharged RFID devices while the one or more RFID devices are traversing the second region.

In some embodiments, a method for reading RFID devices in an RFID reader system includes:
using a conveyor having a first region and a second region, moving one or more RFID devices from the first region to the second region;
using a first transceiver, providing the one or more RFID devices with a precharge using a first command in the first region; and
using a second transceiver, using the precharge to enable communication with the RFID device while the RFID device traverses the second region.

In some embodiments, the term “RFID reader system” refers to an arrangement of one or more devices or components in various embodiments that enables or otherwise supports an efficient, cost effective, and organized reading of RFID tagged items from a pickup or initial location to a desired, final, or drop location. Furthermore, an RFID reader system in some embodiments as used herein enables identification of RFID devices being moved, such as on a conveyor or a conveyor system, on carts, on or in a vehicle such as a car, plane, or boat, or simply an RFID tagged item that has been dropped or is traveling after being thrown or propelled, or during or after unloading of an RFID tagged item to be delivered to a drop location. Moreover, in some embodiments, the RFID reader system provides information about availability and visibility of presence of the RFID devices that may be being transported, such as inside on the conveyor or the conveyor system. In an example embodiment, the item delivery system provides information about the existence, quantity, identity, and/or location of one or a plurality of items being transported, such as inside the on the conveyor or a conveyor system. In some embodiments, the RFID reader system provides a specific location of a target item or a selected item being transported, such as on the conveyor or the conveyor system.

The RFID reader system or method as used herein can be very beneficial wherever improvements in speed and/or accuracy of reading RFID tags may be beneficial. For example, such improvements may be useful for different industries or environments such as delivery, transportation, ecommerce, and/or retail. The improvements of the present disclosure may be used wherever where RFID reader system may be used to locate, identify, sort, store, and/or transport an item, product, and/or package.

The term “RFID tagged items” as used herein may include, but not limited to, inventory items, packages, boxes, gifts, goods, packets, packs, cartons, bundles, boxes, cases, vehicles, carts, pallets, and the like configured or labelled with RFID devices (e.g., RFID tags, RFID labels). In some embodiments, the items or packages are equipped with wireless identification tags such as RFID tags, smart tags, and the like. For example, the wireless identification tags may include one or more of high frequency RFID tags, and low frequency RFID tags. In addition, the wireless identification tags may further include QR codes and/or barcodes.

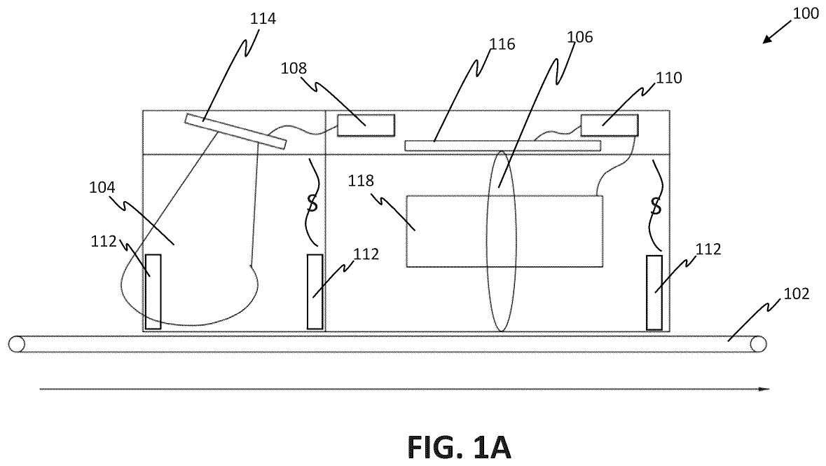

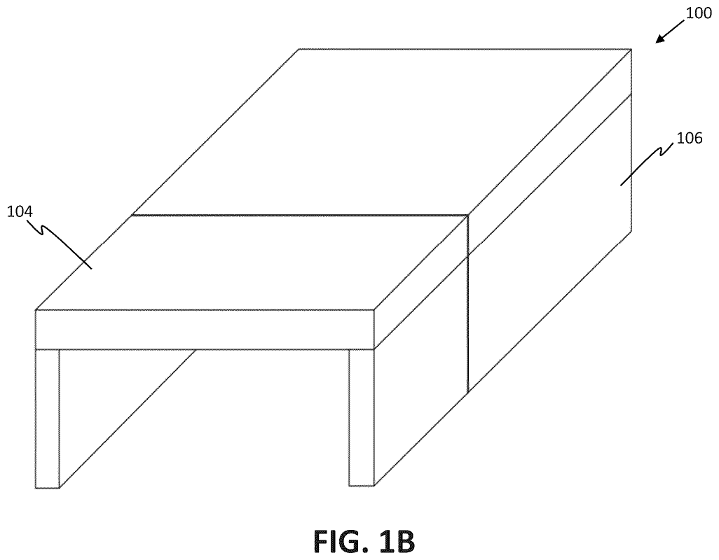

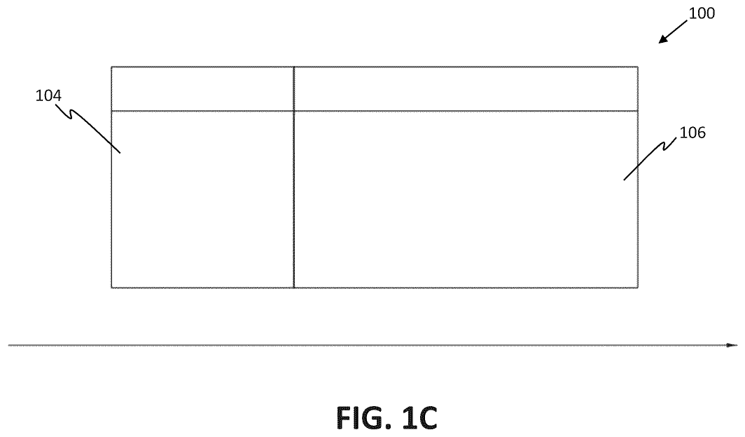

FIGS. 1A, 1B and 1C include illustrations of schematic diagrams of an RFID reader system 100, in accordance with various embodiments. The RFID reader system 100 may include a tunnel reader. FIG. 1A is a cross sectional view of the RFID reader system 100, in accordance with an embodiment. FIG. 1B is a perspective view of the RFID reader system 100, in accordance with an embodiment. FIG. 1C is a side view of the RFID reader system 100, in accordance with an embodiment. The RFID reader system 100 includes a conveyor 102 including a first region 104 and a second region 106. The RFID reader system 100 also includes a first transceiver 108 (e.g., a reader), a second transceiver 110 (e.g., a reader), a first antenna 114, a second antenna 116, and one or more third antennas 118 mounted laterally. The RFID reader system 100 may also include one or more Radio Frequency (RF) light curtains 112. The first antenna 114 may be disposed at an angle to point outward and towards incoming RFID devices, which may extend the length and/or area of the first region 104. The second antenna 116 may be aimed downward from an upper interior ceiling, and may be configured to operate in conjunction with two or more of the third antennas 118 to communicate with RFID devices in the second region 106. The third antennas 118 may be mounted on interior side walls of the RFID reader system 100.

In some embodiments, the conveyor 102 is configured to move one or more RFID devices from the first region 104 to the second region 106. The first region 104 and the second region 106 may each include a region through which RFID devices traveling on the conveyor 102 will pass through in sequence, first through the first region 104 and then through the second region 106. Each of the first region 104 and the second region 106 may be disposed within a different hollow chamber formed above and/or around the conveyor 102.The conveyor 102 may include a conveyor belt that receives the RFID devices or RFID tagged items thereon. In some embodiments, the first region 104 and the second region 106 are disposed on and/or above the conveyor 102 in locations that allow passage of the one or more RFID devices through the first region 104 and into the second region 106. In an event, the one or more RFID devices traverses from the first region 104 to the second region 106. In some embodiments, the first region 104 and/or the second region 106 are less than 1, 2, 3, 5, or 10 feet long (e.g., a greatest dimension).

In some embodiments, the first transceiver 108 is configured to provide the one or more RFID device passing through the first region 104 with a precharge using a first command, such as a select command. The term “precharge” may refer to an activation or actuation of the one or more RFID devices from a deactivated or a sleep configuration to an excited configuration or activated configuration. In some embodiments, “precharge” may simply refer to providing sufficient energy to an RFID device via RF energy to accelerate its response time from one or more milliseconds to microseconds. For example, without a precharge, an RFID device may require greater than 100, 50, 10, or 1 millisecond or 500, 300, 100, 50, 40, 30, 20, 10, or 5 microseconds. With a precharge, an RFID device may respond to a communication request, such as a read request within less than 500, 300, 100, 50, 40, 30, 20, 10, 5, or 1 microseconds. Results and conditions may vary depending on the packaging arrangement for a group of RFID tagged items, the number of RFID tags within or on a package, the speed at which the package travels, the separation space between packages, the power level of the reader and transceiver, and the relative position between the transceiver and the RFID tagged item. While the initial conditions may vary, the improvement in response time based on a precharge may be substantial.

In various embodiments, the first transceiver 108 may be configured as a transmitter to excite the one or more RFID devices in the first region 104. In some embodiment, at high speed conveyors, the pre-charging of the one or more RFID devices provides an adequate amount of energy to the one or more RFID devices to efficiently communicate with readers. In other embodiments, the first transceiver 108 may be configured to precharge the one or more RFID devices packed inside a carton or a box moving on the conveyor 102. In some embodiments, the one or more Radio Frequency (RF) light curtains 112 may reduce leakage of the precharge signals to the one or more RFID devices in the first region 104 and to enable efficient and/or completed communication between the one or more RFID devices and the second transceiver 106.

In some embodiments, the second transceiver 110 is configured to use the precharge to enable and/or complete communication with the precharged one or more RFID devices while the one or more RFID devices are traversing the second region 106. Furthermore, the second transceiver 110 may be mounted to an underroof and/or one or more walls or the floor of the second region 106. The second transceiver 110 may be configured to read the precharged one or more RFID devices in the second region 106. Notably, the second transceiver 110 may establish communication with the precharged one or more RFID devices and read information associated with each of the RFID devices when the precharged one or more RFID devices are completely out of the first region 104 and completely into the second region 106. In some embodiments, the second transceiver 110 may be configured to perform singulation with each of the RFID devices.

In some embodiments, the precharge enables the second transceiver 110 to initiate and perform communication with the precharged one or more RFID devices at a rapid movement of the conveyor 102 with the one or more RFID devices on the conveyor 102. Furthermore, the conveyor 102 (e.g., a conveyor belt, propulsion mechanism for an RFID tagged item) may be configured to move above a speed threshold (e.g., greater than 1, 3, 5, 6, 9, 12 inches per second, 1, 2, 3, 4, 5, 7, 10, 12, 15, 17, 20 25, 30, 50, 75, 100, 125, 150, 200, 250, 500 feet per second) and/or above a volume threshold (e.g., 5, 7, 10, 12, 15, 20, 25, 50, 100, 500, 1000, 2000, 5000, 10000, 20000, 30000, 50000, 100000 tagged items per package or within an area that would correspond in size to the first read zone). In other embodiments, the second transceiver 110 may be configured to read the precharged one or more RFID devices and complete the communication with the precharged one or more RFID devices at the movement speed of the conveyor 102.

In some embodiments, the one or more RFID devices are configured to operate in response to one or more commands received from the first transceiver 104 and the second transceiver 106. Furthermore, the first transceiver 104 and the second transceiver 106 may be configured to provide one or more commands such as selection, activation, actuation, excitation, read, or other commands.

In some embodiments, the one or more RFID devices are configured to exist in a first state and a second state, and may be configured to switch from the first state to the second state or vice versa from the second state to the first state. The switch may occur by itself after a lapse in time and/or after an event has occurred. The trigger to cause a switch may be a particular command from a reader such as one or more of select, inventory, location, or direction.

In some embodiments, the first state of the one or more RFID devices includes a secured state. The secured state may block access to the one or more RFID devices. In other words, the secured state of the one or more RFID devices may be a locked state that restricts activation or reading of the one or more RFID devices. In some embodiments, the second state of the one or more RFID devices includes an accessible state. The accessible state allows communication of the one or more RFID devices with one or more authorized readers. Furthermore, the accessible state may be an open state that enables activation or reading of the one or more RFID devices. In some embodiments, both the first state and the second state are accessible, but a reader may be configured to only read RFID devices found in just one of either the first state or the second state. In some embodiments, the first state and the second state correspond to A and B states of an RFID tag.

In some embodiments, the first transceiver 108 may be configured to activate the first state of the one or more RFID devices and reserve the one or more RFID devices in the secured state or blocked state. In other embodiments, the second transceiver 110 may be configured to activate the second state of the one or more RFID devices in the reading state.

In some embodiments, the RFID reader system 100 also includes a tunnel enclosing the first region 104 and the second region 106. In other embodiments, the RFID reader system 100 also includes one or more sensors to detect a position of the one or more RFID devices. Furthermore, the one or more sensors locate the position on the conveyor 102.

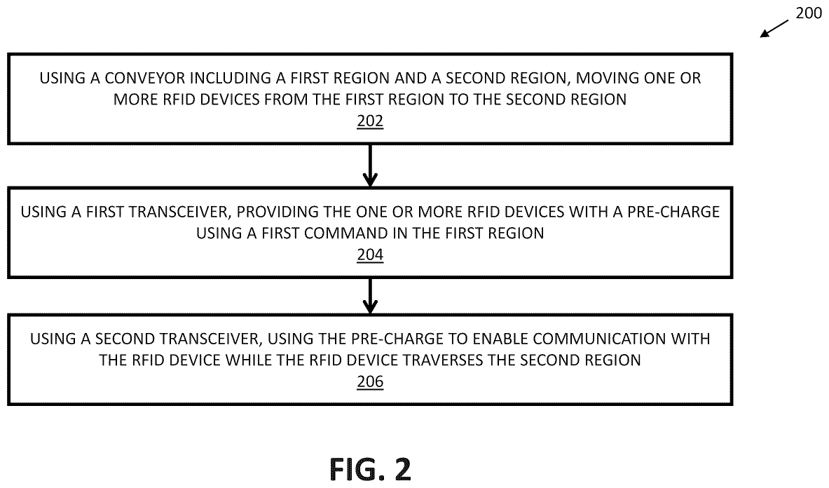

Referring to FIG. 2, there is shown an illustration of a flow chart of a method 200 for reading RFID devices in an RFID reader system, in accordance with an exemplary embodiment of the present subject matter.

At an operation 202, a conveyor having a first region and a second region is used to move one or more RFID devices from the first region to the second region. The conveyor may be provided with a prime mover to traverse the one or more RFID devices from a first region to the second region, such as a belt, a piston, or other device for causing movement. In other embodiments, the RFID devices may be on or attached to a vehicle, or may have been tossed, thrown, or dropped, or otherwise caused to accelerate and/or move.

At an operation 204, a first transceiver is used to provide the one or more RFID devices with a precharge using a first command in the first region. For example, the first transceiver may use a select command that precharges the RFID devices in the first region, enabling them to respond more quickly once they arrive within the second region. Responding more quickly may refer to initiating a response at an earlier time or completing a communication result within less time. For example, initiating a response more quickly may mean starting to respond or completely responding to a reader command when the RFID device has had a precharge in less than 50, 100, 200, 300, 500, 700, or 900 microseconds, 50, 100, 200, 500, 750, or 900 milliseconds, or 1, 2, 3, 4, 5, 7, 10, 20, 30, 40, 50 or 60 seconds. In some embodiments, without the precharge, the RFID device may start to respond or be caused to complete a response in a time period that is more than 25%, 50%, 75%, 100%, 125%, 150%, 200%, 500%, or 1000% greater than with the precharge.

In various embodiments, the first command may further change a state of the RFID devices in the first region from a first state to a second state. In some embodiments, the precharge of the RFID devices caused by the command lasts for a limited duration, such as less than 50, 100, 200, 300, 500, 700, or 900 microseconds, 50, 100, 200, 500, 750, or 900 milliseconds, or 1, 2, 3, 4, 5, 7, 10, 20, 30, 40, 50 or 60 seconds, or 1, 2, 3, 4, 5, 10, or 15 minutes. In some embodiments, the first command is delivered continuously without stopping, continuously on a periodic basis, or once for a single batch of RFID devices passing through the first region.

At an operation 206, a second transceiver is used to utilize the precharge to enable communication with the RFID device while the RFID device traverses the second region. For example, the second transceiver may attempt to read all RFID devices within the second region, all unlocked RFID devices within the second region, all RFID devices only the RFID devices in the first state in the second region, or only the RFID devices in the second state in the second region. The read operation may be performed using a second command, such as a read command. In various embodiments, one or more factors such as the energy from the read command, the speed of the RFID device moving through the second region, the number of RFID devices being read at the same time, the density of the RFID devices, the arrangement of the RFID devices, the amount and/or type of material blocking the transmission of signals to and/or from the RFID devices would prevent the RFID device from being read if it lacked the precharge received while it was in the first region.

In some embodiments, the second command is delivered continuously without stopping, continuously on a periodic basis, or once for a single batch of RFID devices passing through the second region. In some embodiments, the first command is delivered to the first region prior to the second command being delivered to the second region. In some embodiments, the first command and the second command are delivered at the same time, but to two different sets of RFID devices. In various embodiments, continuously may mean without stopping, or without stopping on a periodic basis, based on a timer or clock signal, or based on a trigger such as when a package is entering or has entered a sensor area and/or the first region or the second region.

The operations 202 to 206 are only illustrative and other alternatives can also be provided where one or more steps are added, one or more steps are removed, or one or more steps are provided in a different sequence without departing from the scope of the claims herein.

In some embodiments, the method further comprises operating using one or more commands received from the first transceiver and the second transceiver.

In other embodiments, the method further comprises switching the one or more RFID devices from a first state to a second state.

Modifications to embodiments of the present subject matter described in the foregoing are possible without departing from the scope of the present subject matter as defined by the accompanying claims. Expressions such as “including”, “comprising”, “incorporating”, “have”, “is” used to describe and claim the present subject matter are intended to be construed in a non-exclusive manner, namely allowing for items, components or elements not explicitly described also to be present. Reference to the singular is also to be construed to relate to the plural.

1. An RFID reader system, comprising:
a first region configured to allow movement of one or more RFID devices into the first region, through the first region, and out of the first region
a second region configured to allow movement of the one or more RFID devices into the second region after traveling through the first region, through the second region, and out of the second region;
a first transceiver configured to provide the one or more RFID devices traveling through the first region with a precharge using a first command; and
a second transceiver configured to use the precharge from the first transceiver to accelerate and complete communication with the one or more precharged RFID devices while the one or more precharged RFID devices are traversing the second region.

2. The RFID reader system of claim 1, wherein the precharge enables the second transceiver to initiate and perform communication with the precharged one or more RFID devices moving through the second region at an average rate that is above a threshold.

3. The RFID reader system of claim 2, wherein the threshold rate is at least 3 feet per second.

4. The RFID reader system of claim 1, further comprising a conveyor for transporting the one or more RFID devices through the first region and the second region.

5. The RFID reader system of claim 1, wherein the one or more RFID devices are configured to switch between a first state and a second state.

6. The RFID reader system of claim 5, wherein the first state of the one or more RFID devices includes a secured state that blocks access to the one or more RFID devices in the secured state.

7. The RFID reader system of claim 5, wherein the second state of the one or more RFID devices includes an accessible state that allows the one or more RFID devices in the second state to communicate with one or more authorized readers.

8. The RFID reader system of claim 1, further comprising a tunnel enclosing the first region and the second region.

9. The RFID reader system of claim 1, further comprising one or more Radio Frequency (RF) light curtains disposed between the first region and the second region to avoid leakage of RF signals and to enable efficient communication between the one or more RFID devices and only one of the first transceiver and the second transceiver at a time.

10. The RFID reader system of claim 1, further comprising one or more sensors to detect a position of the one or more RFID devices.

11. A method for reading RFID devices in an RFID reader system that comprises a first region configured to allow movement of one or more RFID devices into the first region, through the first region, and out of the first region, a second region configured to allow movement of the one or more RFID devices into the second region after traveling through the first region, through the second region, and out of the second region, a first transceiver, and a second transceiver, the method comprising
using the first transceiver, providing the one or more RFID devices traveling through the first region with a precharge using a first command; and
using the second transceiver, using the precharge from the first transceiver to accelerate and complete communication with the one or more precharged RFID devices while the one or more RFID devices are traversing the second region.

12. The RFID reading method of claim 11, wherein the precharge enables the second transceiver to initiate and perform communication with the precharged one or more RFID devices moving through the second region at an average rate that is above a threshold.

13. The RFID reading method of claim 12, wherein the threshold rate is at least 3 feet per second.

14. The RFID reading method of claim 11, further comprising a conveyor for transporting the one or more RFID devices through the first region and the second region.

15. The RFID reading method of claim 11, wherein the one or more RFID devices are configured to switch from a first state to a second state.

16. The RFID reading method of claim 15, wherein the first state of the one or more RFID devices includes a secured state, wherein the secured state blocks access to the one or more RFID devices.

17. The RFID reading method of claim 15, wherein the second state of the one or more RFID devices includes an accessible state, wherein the accessible state allows communication of the one or more RFID devices with one or more authorized readers.

18. The RFID reading method of claim 11, further comprising a tunnel enclosing the first region and the second region.

19. The RFID reading method of 11, further comprising one or more Radio Frequency (RF) light curtains disposed between the first region and the second region to avoid leakage of RF signals and to enable efficient communication between the one or more RFID devices and only one of the first transceiver and the second transceiver at a time.

20. The RFID reading method of claim 11, further comprising one or more sensors to detect a position of the one or more RFID devices.

21. The RFID reader system of claim 6, wherein the second state of the one or more RFID devices includes an accessible state that allows the one or more RFID devices in the second state to communicate with one or more authorized readers.
